(19) United States
(12) Patent Application Publication
(10) Pub. No.: US 2026/0094089 A1
(43) Pub. Date: Apr. 2, 2026

(54) DEVAI MODEL AND SYSTEM

(71) Applicant: DevAI Solutions, Inc., Palo Alto, CA (US)

(72) Inventors: Susie J. WEE, Palo Alto, CA (US); Yajun ZHANG, Palo Alto, CA (US); Ignacio VALENZUELA, Palo Alto, CA (US)

(73) Assignee: DevAI Solutions, Inc., Palo Alto, CA (US)

(21) Appl. No.: 19/344,150

(22) Filed: Sep. 29, 2025

Related U.S. Application Data
(60) Provisional application No. 63/701,454, filed on Sep. 30, 2024.

(51) Int. Cl. G06Q 10/0631; G06F 16/3329

(52) U.S. Cl. CPC G06Q 10/06312; G06F 16/3329

(57) ABSTRACT

An artificial intelligence (AI)-powered engine method for collecting information and outputting data. Providing a user interface to allow a user of the AI-powered engine to vary operation of the AI-powered engine. Allowing the user to alter a prompt of the AI-powered engine. Allowing the user to control the information collected by the AI-powered engine. Allowing the user to further vary the operation of the AI-powered engine to enable the user to alter the data which is output by the AI-powered engine.

### CROSS-REFERENCE TO RELATED APPLICATIONS (PROVISIONAL)

This application claims priority to and benefit of co-pending U.S. Provisional Patent Application No. 63/701,454, filed on Sep. 30, 2024, entitled “DEV-AI MODEL AND SYSTEM” by Susie J. Wee et al., and assigned to the assignee of the present application, the disclosure of which is hereby incorporated herein by reference in its entirety.

### BACKGROUND

Within various organizations, certain individuals may develop valuable skillsets and understanding of various processes. Unfortunately, the institutional knowledge of such individuals is often isolated or siloed such that the institutional knowledge of an individual, or a group of individuals, working within one unit of an organization, is not readily shared with individuals working within a different unit of the same organization.

Additionally, different organizations frequently have differing standard operating procedures. As a result, even when a person has significant institutional knowledge pertaining to a unit of an organization, that person's knowledge and skillsets are often not readily transferable or appropriate for use with the standard operating procedures of a different organization. Moreover, even within the same organization, variance between the processes utilized by different units can hinder the effective sharing of institutional knowledge.

### BRIEF DESCRIPTION OF DRAWINGS

The drawings referred to in this Brief Description of Drawings should not be understood as being drawn to scale unless specifically noted. The accompanying drawings, which are incorporated in and form a part of the Description of Embodiments, illustrate various embodiments and, together with the Description of Embodiments, serve to explain principles discussed below, where like designations denote like elements, and:

FIG. 1 is a block diagram depicting features and advantages of the various embodiments in accordance with the present invention.

FIG. 2 is a schematic diagram depicting a Single-shot response embodiment in accordance with the present invention.

FIG. 3 is a block diagram depicting a Retrieval Augmented Generation (RAG) system embodiment in accordance with the present invention.

FIG. 4 is a block diagram depicting a Table Augmented Generation (TAG) system embodiment in accordance with the present invention.

FIG. 5 is a block diagram depicting an Orchestration Agent embodiment in accordance with the present invention.

FIG. 6 is a depiction of a graphic user interface (GUI) for customized generation of prompts in accordance with an embodiment of the present invention.

FIG. 7 is a depiction of another graphic user interface (GUI) for customized generation of prompts in accordance with an embodiment of the present invention.

FIG. 8 is a depiction of a graphic user interface (GUI) including an agent in accordance with an embodiment of the present invention.

FIG. 9 is a flow chart of steps performed in accordance with an embodiment of the present invention.

FIG. 10 is a block diagram of an example computer system with which or upon which various embodiments of the present invention may be implemented.

FIG. 11 is a depiction of a graphic user interface (GUI) for analyzing data discrepancy in accordance with an embodiment of the present invention.

FIG. 12 is a depiction of a graphic user interface (GUI) for analyzing data discrepancy in accordance with an embodiment of the present invention.

FIG. 13 is a depiction of a graphic user interface (GUI) for analyzing data discrepancy in accordance with an embodiment of the present invention.

FIG. 14 is a depiction of a graphic user interface (GUI) for analyzing data discrepancy in accordance with an embodiment of the present invention.

FIG. 15 is a depiction of a graphic user interface (GUI) for analyzing data discrepancy in accordance with an embodiment of the present invention.

FIG. 16 is a depiction of a graphic user interface (GUI) for providing Insights and Reports functionality in accordance with an embodiment of the present invention.

### DETAILED DESCRIPTION

For purposes of clarity and brevity, the following description of the present invention is provided with examples of an implementation of the present invention in a Networked Information Technology environment. The present invention is, however, well suited to use in various other environments and fields of technology.

In various embodiments, the present invention provides a system and methodology which significantly improves an organization's (e.g., a company's) ability to effectively handle various operations. As will be discussed in detail below, various embodiments of the present invention uniquely allow an organization to create, capture, share, scale and modify institutional knowledge. Moreover, various embodiments of the present invention provide such significant improvements to an organization's operations in a manner that can be uniquely tailored or customized to meet the standard operating procedures, needs, requirements and/or preferences of the organization. Embodiments of the present invention also enable an organization to maintain consistency in various operating procedures across the multiple units (e.g., the various business units/entities/departments) of the organization.

As stated above, for purposes of brevity and clarity, the following description of the various embodiments of the present invention is provided with examples pertaining to implementation of embodiments of the present invention within a Networked Information Technology environment. Again, it should be noted that the various embodiments of the present invention are well suited to use in various other environments and fields of technology.

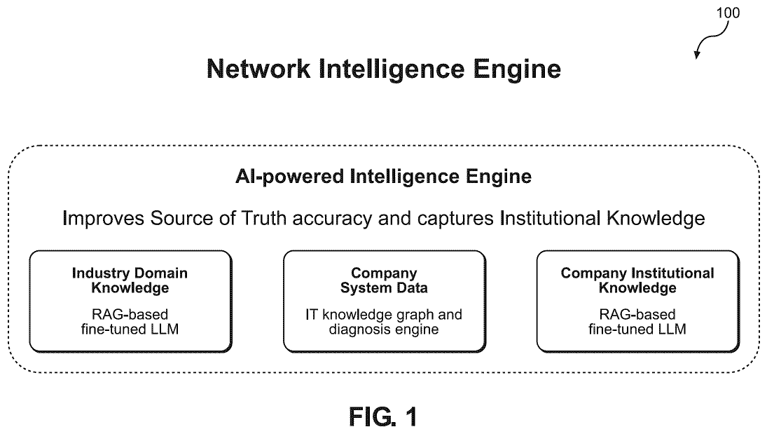

Referring now to FIG. 1, a block diagram 100 is provided which describes some of the features and advantages of the various embodiments of the present invention. As will be discussed in detail below, embodiments of the present invention provide a significantly improved Artificial Intelligence (AI)-powered engine that uniquely brings together industry domain knowledge, company institutional knowledge, and currently siloed Information Technology (IT) system data from, for example, Configuration Management Database (CMDB) tools, IP Address Management (IPAM) tools, observability tools, vendor tools, and the like. In so doing the present invention makes it possible for an organization to appropriately create, capture, share, scale and modify data and institutional knowledge. Additionally, it should be noted that the embodiments of the present invention are well suited to use with any of the various AI-powered engines in the manner described below.

### Overview of Embodiments of the Present Invention

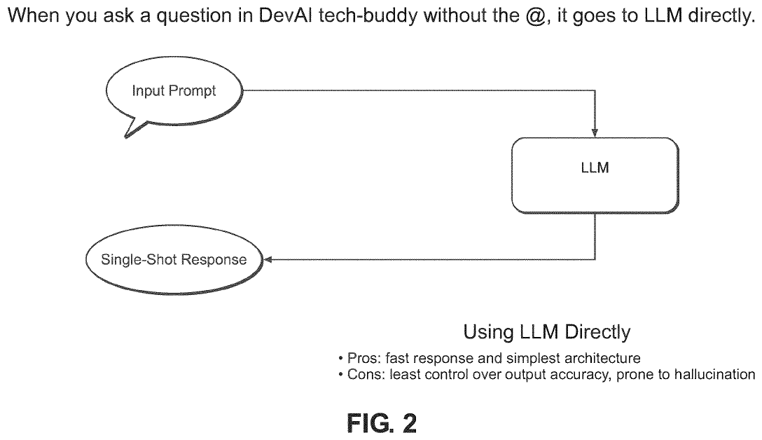

Referring now to FIG. 2 a schematic diagram 200 depicting an embodiment of the present invention is shown. In the present embodiment, the present invention utilizes an input prompt in connection with a Large Language Model (LLM) to provide a Single-shot response. Importantly, embodiments of the present invention are trained from the IT community such that the prompts and the LLM of the present invention will answer questions to IT specific problems in an advanced and novel way.

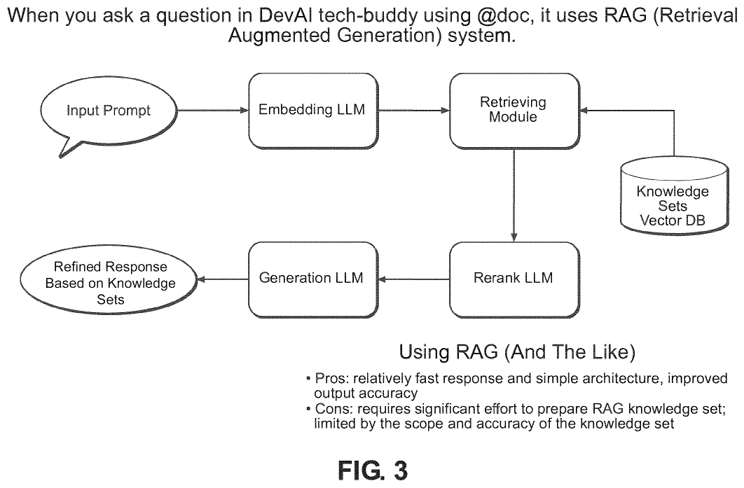

Referring now to FIG. 3, a schematic diagram 300 depicting another embodiment of the present invention is shown. In the present embodiment, the present invention utilizes a Retrieval Augmented Generation (RAG) system based on a Large Language Model (LLM) which is trained with documents and information. In the embodiment of FIG. 3, an embedding LLM, a retrieving module, a knowledge sets database vector database (DB), a rerank LLM and a generation LLM are utilized to provide a refined response to an input prompt based on various knowledge sets. Importantly, embodiments of the present invention are trained from the IT community such that the present invention will answer questions to IT specific problems in an advanced and novel way. Additionally, embodiments of the present invention are tailored to specific to each user's business. More specifically, embodiments of the present invention novelly utilize an IT intelligence engine (also referred to herein as a network intelligence engine) look at company specific system data. For example, embodiments of the present invention connect up to the CMDB, IT tools, observability tools, or various other information that a particular company uses.

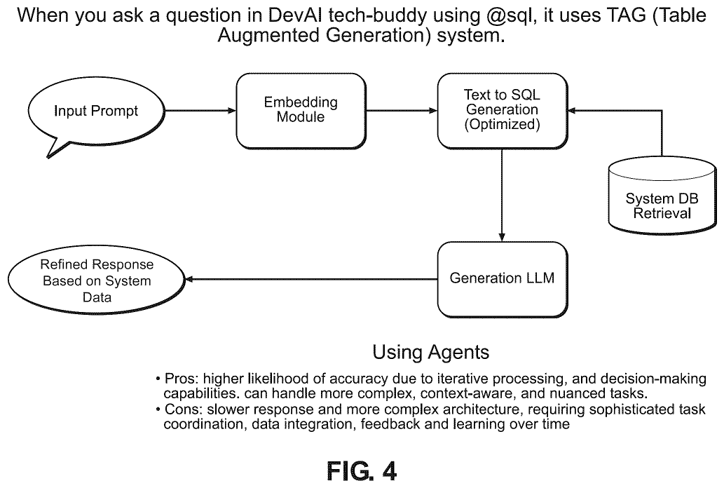

Referring now to FIG. 4, a schematic diagram 400 depicting another embodiment of the present invention is shown. In the present embodiment, the present invention utilizes a Table Augmented Generation (TAG) system in combination with an embedding module, a text to Structured Query Language (SQL) module, a system DB retrieval, and a generation LLM to provide a refined response to an input prompt based on system data. Importantly, embodiments of the present invention are trained from the IT community such that the present invention will answer questions to IT specific problems in an advanced and novel way. Additionally, embodiments of the present invention are tailored to specific to each user's business. More specifically, embodiments of the present network intelligence engine look at company specific system data.

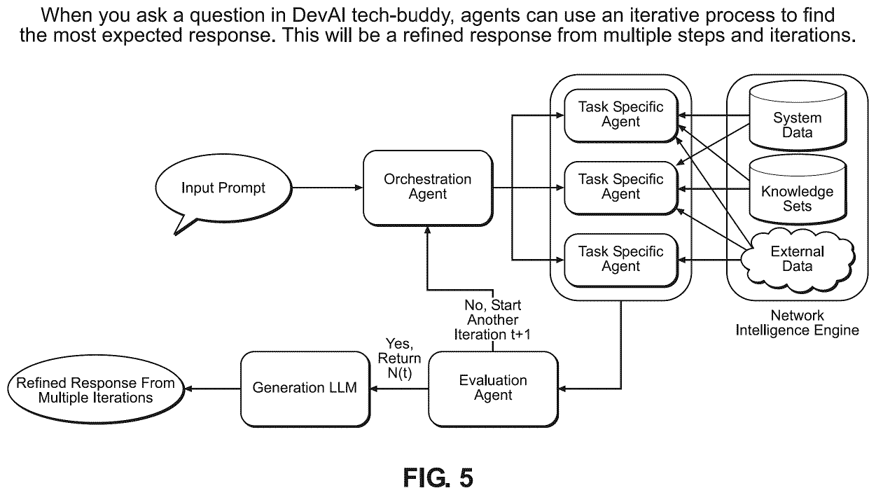

Referring now to FIG. 5, a schematic diagram 500 depicting another embodiment of the present invention is shown. In the present embodiment, the present invention utilizes an orchestration agent in combination with, for example, a set of task specific agents and a network intelligence engine (including system data, knowledge sets and external data), an evaluation agent, and a generation LLM to provide a refined response to an input prompt wherein the refined response is generated from multiple iterations and recursive analysis by user of the AI-powered engine. Importantly, embodiments of the present invention are trained from the IT community such that the present invention will answer questions to IT specific problems in an advanced and novel way. Additionally, embodiments of the present invention are tailored to specific to each user's business. More specifically, embodiments of the present network intelligence engine look at company specific system data.

### Operation of Embodiments of the Present Invention

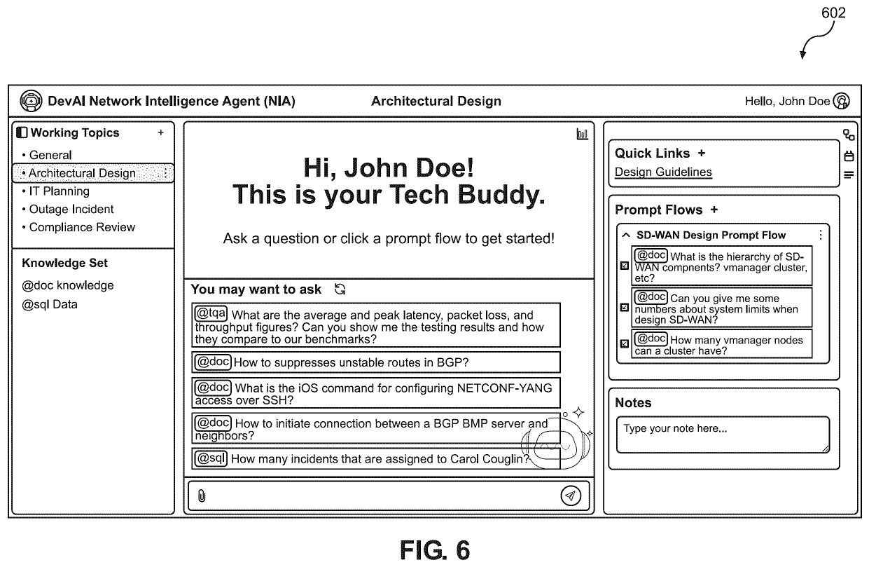

With reference now to FIG. 6, a graphic user interface (GUI) 602 is provided in accordance with an embodiment of the present invention. As will be discussed in detail below, embodiments of the present invention significantly improve an organization's ability to generate prompts, generate prompt flows and manage prompts. Moreover, various embodiments of the present invention provide such significant improvements to prompt generation, prompt flows and prompt management in a manner that can be uniquely tailored or customized to meet the standard operating procedures, needs, requirements and/or preferences of the organization. Embodiments of the present invention also enable an organization to maintain consistency in prompt generation, prompt flows and prompt management across the multiple units of the organization.

Many conventional chat systems and/or various AI-powered engines use only a provided chat window for interaction with a user. The present invention, however, utilizes a novel prompt format wherein the working topics are located, for example, on the left of, for example, GUI 600 and the answers that are provided to users are specific to each working context or fall within each working topic such that the answers are contextual to that topic. Moreover, embodiments of the present invention specifically alter and customize the prompt creation, capture, modification and scaling process provided by the AI-powered engine to meet the specific type of inquiry to which the prompt is directed (e.g., IT-directed prompt, a human resources-directed prompt, a CMDB-directed prompt, and the like. Furthermore, embodiments of the present invention specifically alter and customize the prompt creation, capture, modification and scaling process provided by the AI-powered engine in order to provide a role-based prompt creation, capture, modification and scaling process. As yet another altering of conventional chat systems and/or various AI-powered engines, embodiments of the present invention specifically alter and customize the prompt creation, capture, modification and scaling process provided by the AI-powered engine in order to provide an organization-customized and/or a working context (e.g., a corporation/company-customized, a business unit-customized, a specific user type-customized, and the like) prompt creation, capture, modification and scaling process. Each of the prompt-process variations provided by the present invention alterations provide a significantly improved AI-powered engine that uniquely brings together industry domain knowledge, company institutional knowledge, and currently siloed IT system data from, for example, CMDB tools, IPAM tools, observability tools, vendor tools, and the like.

Furthermore, in one embodiment of the present invention, the prompt flows conventionally provided by the AI-powered engine are specifically altered such that the entire prompt creation, capture, modification and scaling process is tailored to be contextual to the working topic. For example, in one embodiment, the present invention revises and alters the input prompts provided to the user, and then entered to the AI-powered engine, such that the prompts are specifically altered to provides a different initial prompt and subsequent prompt answer for a user working in architectural design. Similarly, in embodiments of the present invention, the AI-powered engine is specifically altered such that the AI-powered engine provides a different answer to the same user prompt for a user working in IT planning as compared to a user who, for example, is not working in IT planning.

Such alterations to the AI-powered engine are achieved by varying the operation of the AI-powered engine to define the parameters initially used by the AI-powered engine to, for example, create prompts. Additionally, the embodiments of the present invention further recursively alter the operating parameters of the AI-powered engine until the results of the prompt from the AI-powered engine are consistent with the intended objectives. For example, an IT administrator may observe that prompt results from the AI-powered engine are not consistent with IT polices or processes. The IT administrator will then adjust the operating instructions and parameters of the AI-powered engine until the results provided by the AI-powered engine are consistent with IT polices or processes. In embodiments of the present invention, not only are the input prompts recursively examined (with corresponding alterations to the AI-powered engine), but the outputs from the AI-powered engine are also recursively examined (with corresponding alterations to the AI-powered engine) until the entire process flow (e.g., prompt creation, capture, modification and scaling) and the results generated by the AI-powered engine are consistent with the desired result. Importantly, in embodiments of the present invention, as described in the above examples, the alteration of the prompts/prompt flows to adjust the output of the AI-powered engine, are performed by the subject matter experts (those with the most and best institutional knowledge) in the tasks and/or objectives corresponding to the altered prompts/prompt flows. Moreover, such subject matter experts are often those personnel having the greatest understanding of the organization's internal processes and of the organization's metes and bounds of operation. That is, embodiments of the present invention provide a system and methodology which significantly improves the accuracy and appropriate nature of the output from the AI-powered engine by having the subject matter experts alter and adjust the prompt(s)/prompt flow and output of the AI-powered engine. In embodiments of the present invention, for example, the input prompts are recursively examined and altered, the outputs from the AI-powered engine are recursively examined and altered, and the like, until the entire process flow, and the results therefrom, meet an organization's (or e.g., a business unit's, a person's) objectives and comply with standard operating procedures, needs, requirements and/or preferences of the organization. Additionally, in embodiments of the present invention, the input prompts are recursively examined and altered, the outputs from the AI-powered engine are recursively examined and altered, and the like, until the entire process flow, and the results therefrom, enable an organization to maintain consistency in various operating procedures across the multiple units (e.g., the various business units/entities/departments) of the organization.

As a result, of the altering of the operation of the AI-powered engine, embodiments of the present invention provide a system and methodology which significantly improves an organization's ability to effectively handle various operations. As will be discussed further below, embodiments of the present invention uniquely allow an organization to create, capture, share, scale and modify institutional knowledge. Moreover, various embodiments of the present invention provide such significant improvements to an organization's operations in a manner that can be uniquely tailored or customized to meet the standard operating procedures, needs, requirements and/or preferences of the organization. Embodiments of the present invention also enable an organization to maintain consistency in various operating procedures across the multiple units (e.g., the various business units/entities/departments) of the organization. Also, embodiments of the present invention provide the significant improvement to existing processes and methodologies to now uniquely enable an organization to control the querying of various operations in a customized and role-based manner across any of the multiple units of the organization.

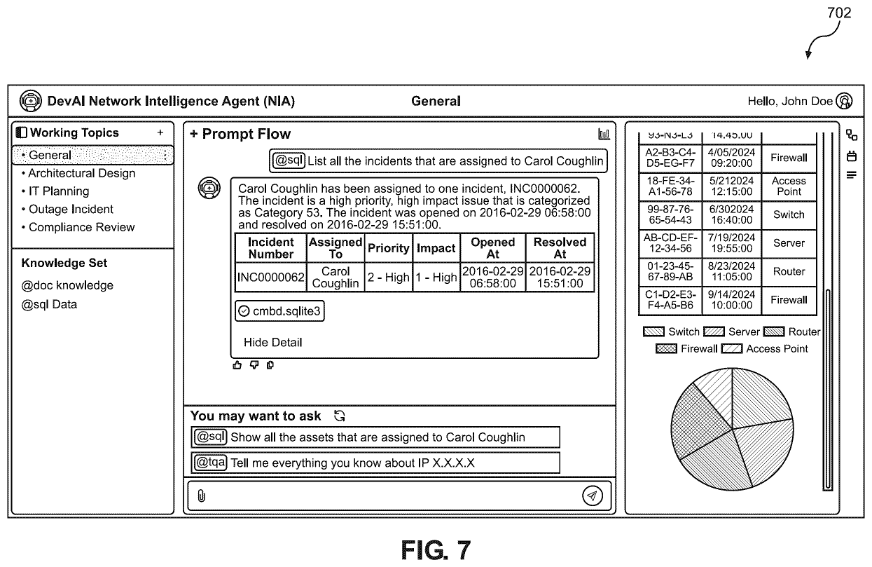

Referring now to FIGS. 6 and 7, in embodiments of the present invention, a network administrator (or another authorized user) will utilize GUI 602 and/or GUI 702 to alter the operation and/or parameters of the AI-powered engine to ensure that prompt(s) and/or answers to the prompt(s) or prompt flows appropriately produce an output which is consistent with IT policies or processes. Moreover, in various embodiments of the present invention, GUI 602 and/or GUI 702 are used (by an authorized user) to alter the operation and/or parameters of the AI-powered engine to produce a different answer/output to the same user prompt for a user working on an outage incident than the answer/output which is provided to the same user or another user who is working on a different type of incident (e.g., non-outage incident).

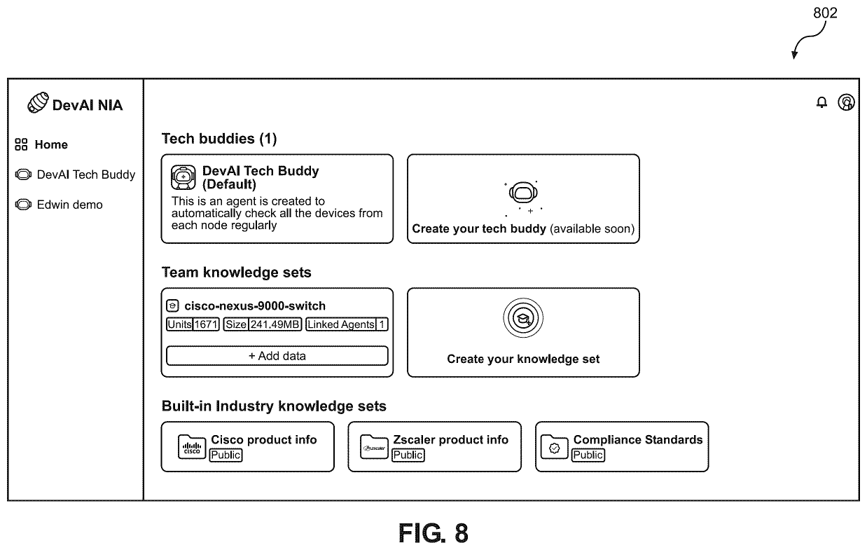

Still referring to GUI 602 and GUI 702 of FIG. 6 and FIG. 7, respectively, in one embodiment of the present invention, a widget(s) is/are provided to activate the present system and method. Thus, when a user is, for example, working on e-mail or checking their system monitoring tool, in one embodiment of the present invention, the list of the working topics or whatever is important to that user will appear on the user's screen. For example, if a user is working on specific context in their Slack or web Microsoft Teams application, a widget is available. In one embodiment of the present invention, the UI (e.g., GUI 602 of FIG. 6, GUI 702 of FIG. 7 and/or GUI 802 of FIG. 8) of the present system and model is fully expandable with different panels depending on the topic. Thus, when the user desires to provide contextual data to further illustrate the answer, the present invention will automatically provide the appropriate detail screen to show the additional details of the data and also the visualization. Additionally, in one embodiment of the present invention, when the generated response is unduly long, the present system and model will provide the significant improvement to existing processes and methodologies to now uniquely provide a summary answer. Further, in one embodiment of the present invention, if the user chooses to show more details an expandable table is made available to show the user the entire answer or everything that relates to the answer. That is, in one embodiment of the present invention, the GUI is expandable depending on a user's working topic, depending on their task and/or depending on the exact answer provided by the present system and model.

In one embodiment of the present invention our agent is able to cross validate data from different agents. Additionally, embodiments of the present invention are also able to operate without such integration in a more linear manner.

Often, when information is collected across multiple business units and/or from multiple tools/systems, conflicts can occur in the collected information. Embodiments of the present invention provide the significant improvement to existing processes and methodologies to judge the collected information and decide how to resolve such conflicts. One embodiment of the present invention implements a scoring system for the collected information. For example, in one embodiment, internal data will have a higher score compared to external data. In one embodiment, scoring is based on the time awareness. For example, embodiments of the present invention provide the significant improvement to existing processes and methodologies such that the latest data stamp will have a higher score than, for example, historical data.

In one embodiment, by taking feedback from the users over the time, the present invention provides the significant improvement to existing processes and methodologies by refining and defining the model (e.g., refining and defining the prompts and the output from the AI-powered engine) using the time-established judgement and experiences of the users of the present invention. That is, embodiments of the present invention provide the significant improvement to existing processes and methodologies by uniquely employing an approach herein referred to as hybrid knowledge validation.

In one embodiment, the present invention also includes an orchestration agent (see e.g., FIG. 4). In one embodiment, the present invention is able to call the orchestration agent directly. In one embodiment, the call to the orchestration agent is made using the UI (e.g., GUI 602 of FIG. 6, GUI 702 of FIG. 7 and/or GUI 802 of FIG. 8).

Also, in one embodiment, the present invention will utilize an orchestration agent to determine based, for example on the context of the task, which agents the orchestration agent will call. That is, various embodiments of the present invention provide the significant improvement to existing processes and methodologies to enable some routing policies to be based on the context of the inquiry.

Additionally, in various embodiments of the present invention, an inquiry from the system or a user may involve, for example, company sensitive data, data external to the company or other sensitive data. Thus, in various embodiments, the present invention will identify any sensitive data, and, when appropriate, such sensitive data is, for example, filtered, eliminated from the result or similar. As another example, such sensitive data could include a specific IP address, a password, etc. In one embodiment, the present invention utilizes a conversion rule there to ensure that further distribution of the sensitive data is prevented.

Hence, various embodiments of the present invention provide the significant improvement to existing processes and methodologies such that, even while improving query or retrieval accuracy, the present invention will still identify sensitive data (which conventional systems would report) like IP addresses, Mac addresses, and the like.

Referring again to FIG. 1, a box is shown surrounding the system data, knowledge sets and external data (shown as the Network Intelligence Engine), because, in one embodiment, the present invention, performs computing around those as systems as well. In various embodiments, the present invention takes that data in and then computationally retrieves and communicates with different underlying systems and tool sets like, for example, IT tools and different data sources. In various embodiments, the present invention extracts information (sometimes referred to as institutional knowledge) from, for example, employee notes, unstructured data, physio-network diagrams, whiteboards, electronic whiteboard documents, and the like. Also, various embodiments of the present invention are not necessarily one-to-one where each agent access only a single knowledge/data source. Instead, in various embodiments, the present invention provides the significant improvement to existing processes and methodologies to enable a one-to-many or even an all-to-all approach such that there is a crossing or overlap of knowledge/data sources and layers of agents such that information is put at least partially combined before being accessed by a task specific agent.

The present invention provides a system, method and model for empowering enterprise information technology (IT) with a network intelligence engine or a network intelligence agent system. Embodiments of the present invention empower enterprise IT teams (e.g., the folks who build out the network, directors, architects, engineers and operators). Embodiments of the present invention also provide an AI companion that helps to speed up their work, helps users serve their customers and helps users have time to grow their business.

Embodiments of the present invention empower users with an AI-powered engine/AI companion that sits on top of a network intelligence engine (see, e.g., FIG. 1), which is capturing intelligence about what's going on in the network, it's configurations, it's changes etc., to help users with their tasks.

Referring now to FIG. 6, in embodiments of the present invention, users of GUI 602 can “thumbs up” or “thumbs down” various prompts to come up with queryable prompt flows, but, in one embodiment, the present invention allows users to “thumbs up” or “thumbs down” even the variables within the prompt flows.

In one embodiment, the present invention provides the significant improvement to existing processes and methodologies that now uniquely enables the insertion of variables so that then the prompt flows come out as desired by the user, and then finally the defined prompt flows are able to be beneficially utilized by users of the present invention.

In one embodiment, the present invention provides the significant improvement to existing processes and methodologies to now uniquely enable actionable prompt flows and then a system that transfers prompt flows to workflows.

In one embodiment, the present invention provides the significant improvement to existing processes and methodologies to now uniquely enable actionable actions which are also editable. Additionally, in one embodiment the present invention provides the significant improvement to existing processes and methodologies to now uniquely enable those actions also get customized, for example, a company's specific IT environment. Hence, the present invention provides the significant improvement to existing processes and methodologies such that users of the present invention have the variables to perform the above-described prompt generation, and users can connect to the automation system of the present invention to do that.

In one embodiment of the present invention, the present system and model includes an additional element. Specifically, in one embodiment of the present invention, the interaction of the prompt flow with the data screen is significantly improved. As an example, assume a user is dealing with a medium incident. In one embodiment of the present invention, the suggested prompt provided to the user will be in the context of dealing with a medium incident. As a result, in one embodiment of the present invention, the user will receive the answer from their next question right in the prompt, and within the context of dealing with a medium incident. Thus, in one embodiment of the present invention, the contextualized prompts continue to be contextual and, and relevant even as the user nests deeper and deeper into the data. As a result, in one embodiment of the present invention, the context from the data screen is carried back to the chat on GUI 602 or GUI 702, and by providing context in such a manner, the present invention provides the significant improvement to existing processes and methodologies to now uniquely easily share context, provide ease of use to the user, and drive forward the conversation.

Referring now to FIG. 8, GUI 802, in one embodiment of the present invention, the agent system builder provides customized agents that are made for the different purposes. As an example, if a user is teaching someone how to troubleshoot a problem in a Latin America office versus a Southeast Asia office, due to differing procedures, the prompt flows may be different for each location. Moreover, in one embodiment of the present invention, as users build up the agents and the knowledge bases, for example, a specific list of routers, the list may be different for different areas. Thus, in one embodiment of the present invention, agents can also be customized for the person who's using them. Also, in one embodiment of the present invention, role-based access control is available. Thus, power users who have more permissions and privileges may have agents with more capabilities than agents customized for non-power users.

Also, embodiments of the present invention generate and utilize a set of prompt flows. Specifically, embodiments of the present invention create a set of prompt flows such as, for example, a set of prompt flows which guide a user to ask appropriate questions regarding various tasks. Such questions prompted by embodiments of the present invention include, for example, “How do I solve this incident”. Other questions prompted by embodiments of the present invention include, for example, “How do I do this thing”. Moreover, actions performed by embodiments of the present invention include, for example, enabling a relevant community to create prompt flows and empower users within a company or a specific industry. Embodiments of the present invention enable skilled or knowledgeable users to submit a particularly relevant or beneficial prompt flow. Moreover, embodiments of the present invention provide the significant improvement to existing processes and methodologies to now uniquely enable a company's specifically refined prompts to be applicable to a more general application of such prompts within other companies or industries.

In embodiments of the present invention, prompt flows such as, for example, “How is this IP address configured”, “How is the device with this IP address performing”, “Does the device with this IP address have an outdated configuration?” are provided. Thus, embodiments of the present invention provide the significant improvement to existing processes and methodologies to now uniquely enable a user to correctly and quickly determine if the device will give IP address output which needs to be updated. That is, embodiments of the present invention enable using an IP address as a variable so that users can utilize the IP address (and answers to prompts about that IP address as a variable. Hence, the present invention provides the significant improvement to existing processes and methodologies such that information and prompts related to, for example, a specific IP address can be used with other information or prompts.

Furthermore, embodiments of the present invention provide the significant improvement to existing processes and methodologies such that obtained data, and even the prompt flow itself, enables the further creation of a customized prompt flow via, for example, GUI 602, GUI 702 and/or GUI 802. Moreover, in various embodiments, the AI-powered engine, the various databases, systems, process and the like of the present invention, are constantly being trained/updated on a knowledge set. As a result, embodiments of the present invention provide the significant improvement to existing processes and methodologies such that the present invention gets smarter over time. Additionally, embodiments of the present invention provide the significant improvement to existing processes and methodologies such that the present invention is also able to be trained on public information as well as internal/private data. Also, embodiments of the present invention provide the significant improvement to existing processes and methodologies by also bringing in data from the CMDB such as, for example, a ServiceNow CMDB.

Embodiments of the present invention also include incident management tools as well. Also, embodiments of the present invention treat system data differently. Moreover, embodiments of the present invention provide the significant improvement to existing processes and methodologies to examine numbers, find conflicts, and make sense out of the number and conflicts. That is, embodiments of the present invention provide the significant improvement to existing processes and methodologies to novelly add intelligence around obtained data. Specifically, embodiments of the present invention provide the significant improvement to existing processes and methodologies to novelly obtain data, novelly handle the date, novelly examine the obtained date, and novelly finds conflict with the obtained data

### Example of Operation and Implementation

As an illustrative example, assume that ROY is the seniormost networking guy at BigCo. He doesn't have management responsibility for all the networkers, but he has responsibilities for keeping the network architecture up and running. ROY is constantly looking at the network architecture strategy, constantly looking at new products, constantly thinking about what the network will need to look like now, in the next 5-10 years, in the next twenty years in order to keep the business running.

ROY is also always looking at the new technologies. ROY must consider which new technologies he will need to know about to make sure that his company has the optimal network system/solution possible. ROY then has to communicate with others at BigCo, because ROY has to get everybody to come along with him as ROY moves forward. ROY also has to make sure that he gets executive support to sponsor ROY's proposed changes/improvements and advances in the correct manner and timeframe.

When ROY's company starts building out, per ROY's proposal, ROY needs to make sure that at BigCo, everyone across the organization is working to implement ROY's proposed changes/improvements. Ultimately, of course, ROY's goals for networking and ROY's various other proposed changes/improvements require meeting architecture needs to support the network, providing network security to protect against cyber-attacks, data breaches, and ensuring the network meets reliability and uptime criteria.

Additionally, when looking out for network outages, ROY will need disaster recovery plans. When looking at network performance, ROY needs to make sure that various business applications work really well, that appropriate cloud services are enabled, and ROY also has to consider capacity planning for the network. Moreover, while ROY may not personally be in charge of the network operation center, for example, ROY still has to ensure that the network architecture serves all aspects of the various network personnel and their respective needs. In essence, all of those associated with the network at all units of BigCo are ROY's customers as well. But the problem that ROY has is actually that ROY gets called all the time. He is bombarded because ROY has all of the aforementioned duties and responsibilities. So, ROY has to talk both “upwards” and “downwards” at BigCo in order to handle his tasks, meet forward-looking demands and obtain the information necessary for ROY to appropriately perform at BigCo.

It is apparent from the above ROY is needed everywhere all the time. As a further example, ROY gets requests of all types from across the entirety of the business units at BigCo. For example, “Hey ROY, we have a new service. Can you check how much capacity there is left?; “Can we do this, ROY?”; “Oh, ROY, we have a board meeting next week so we need information about . . . ”; “How's our security audit going, ROY?”; “What's the state of our systems, ROY?”; “Oh, ROY, we need to do IT planning. What should we buy next year?” and the like. As a result, ROY may need to figure out, for example, which routers are actually in use (or not), or in production, or answer (or help to resolve) any of a myriad of inquiries.

The problem with conventional approaches is that for everything that ROY needs to get done, even when there is a team around him, that process is still very manual. Moreover, many of the tools used by ROY and his team are dedicated to one particular issue (e.g., siloed by task, siloed by business unit, siloed by personnel, and the like). As a result, ROY and his team are frequently required to check all or many of the different tools in use across BigCo. ROY needs to look at websites, look at source of truth systems (e.g., ServiceNow), CMDB, various IT tools, live tools, observability tools, and the like, in order to find and analyze the information to answer the fundamental question: “How things are going, ROY?”. Additionally, many tools, for example, source of truth tools, have unique network diagrams of the network architecture. Moreover, individual team members often keep their own personal notes. So, ROY needs to analyze an immense amount of disparate data both to solve important problems like an outage, to deal with IT planning, and basically any other issue. The problem is that IT teams need to figure out what information do they have, or even where the information is. IT teams are often left asking where are my network routers, devices, firewalls, etc.? How are they connected? What state are they in? How long does their software license last? What capabilities are they?

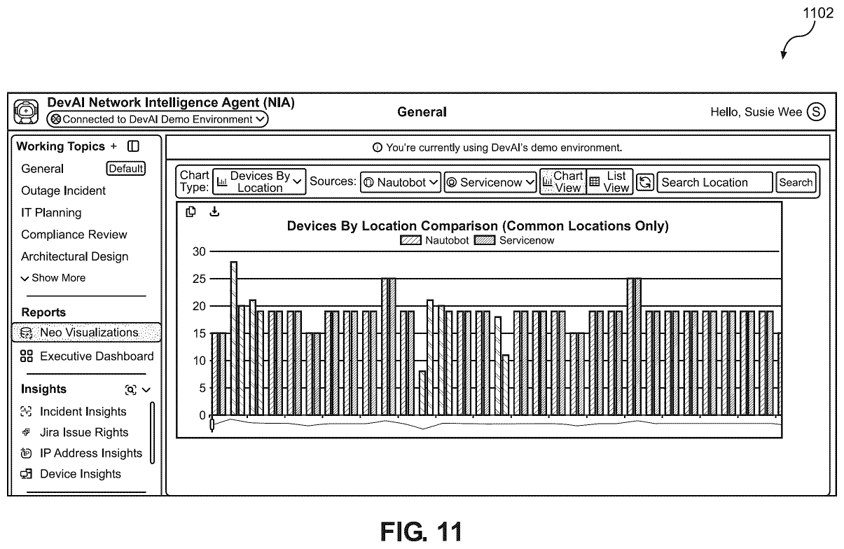

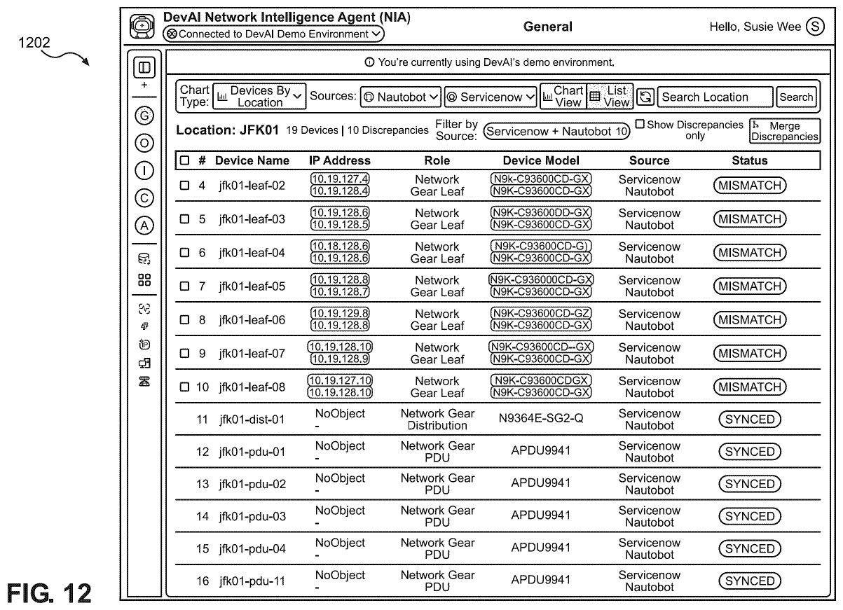

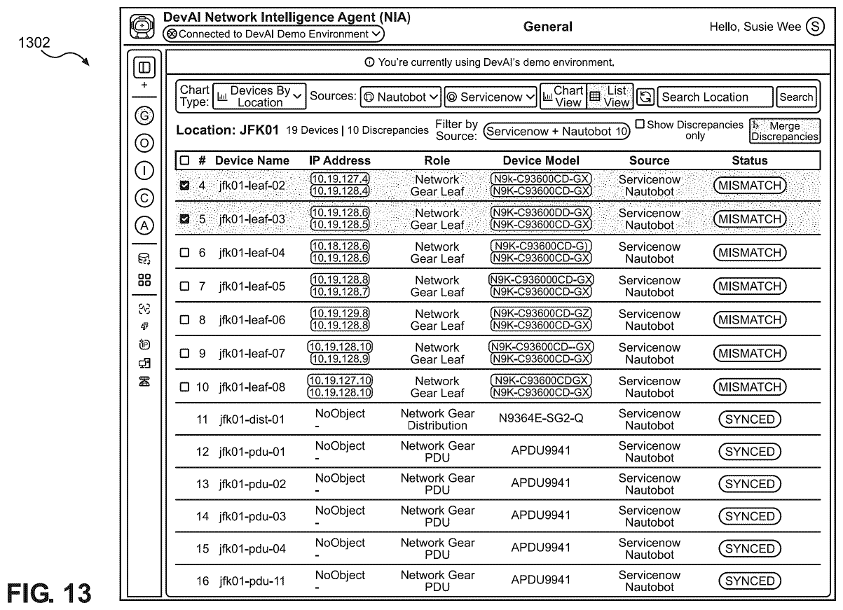

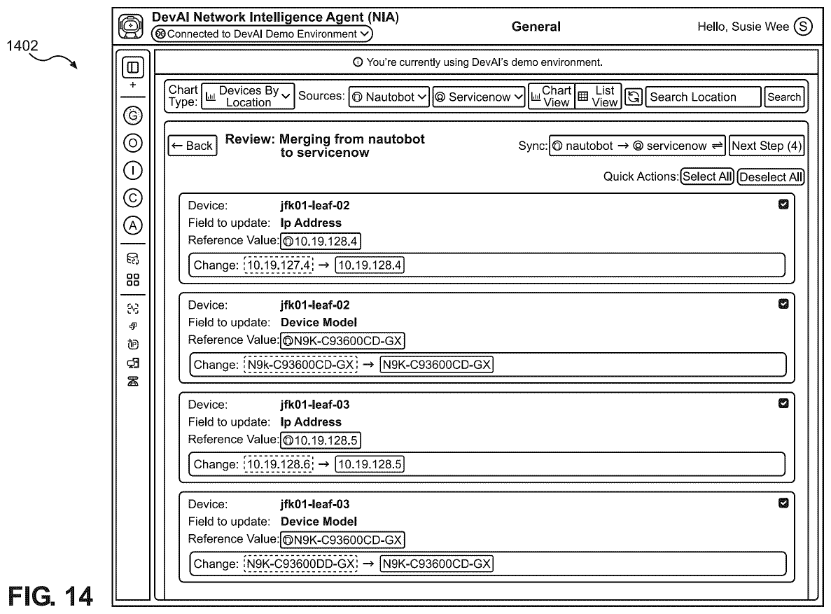

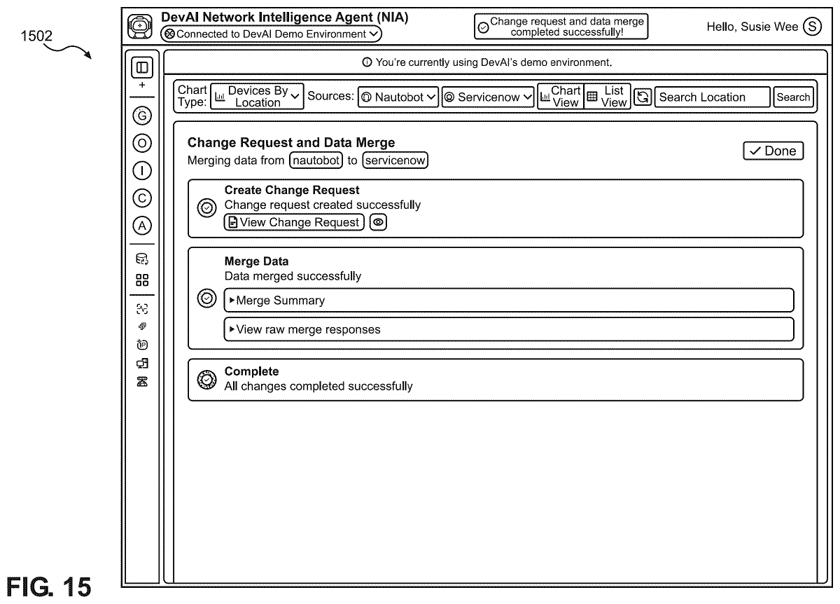

As a result of the complexity and siloed nature of information, conventional approaches to gathering information are often incomplete, incorrect or take too much time to answer any question as the existing IT tools are often very disjointed and fragmented. Therefore, the tasks ROY would have complete using conventional approaches are very manual and extremely time-consuming. Additionally, conventional approaches often have inaccurate source of truth systems in place. While such conventional approaches might be slightly more accurate at first, such conventional approaches tend to drift over time and become less accurate. For example, when there's an outage, a broken device may be replaced, but frequently no one has accurately recorded which device was broken and/or the information about the replacement device. As a result, conventional approaches often drift down to 60 percent to 80 percent accuracy, which means that when users are dealing with an outage, the users cannot count on their data sources because the data are not correct. In various embodiments, such shortcomings of the conventional approaches are overcome by the present invention creating a mapping between the various tools utilized within an organization and/or between an organization's internal tools and external data. Importantly, embodiments in accordance with the present invention, enable personnel such as, for example, ROY, after finding discrepancies in the data of different tools, to alter, adjust and/or replace any portion of or all of the data having inaccuracies or a lower source of truth value with a portion or all of the data (from e.g., a different tool, data from the same tool but from a different business unit, and/or any other data) which has less inaccuracies and/or a higher source of truth value. Moreover, in various embodiments of the present invention, such “data cleansing” is able to be performed, in some instances, by, for example, a subject matter expert like ROY. Hence, embodiments of the present invention provide the significant improvement to existing processes and methodologies to novelly improve data accuracy and/or the source of truth across the entirety an organization (and in accordance with the standard operating procedures, needs, requirements and/or preferences of the organization) using, for example, one or more of GUI 1102 of FIG. 11, GUI 1202 of FIG. 12, GUI 1302 of FIG. 13, GUI 1402 of FIG. 14 and GUI 1502 of FIG. 15.

Additionally, in various embodiments of the present invention, the network intelligence engine (see, e.g., FIG. 1) finds the aforementioned differences/discrepancies in the data and further offers ways to cleanse the data. In some embodiments, the present invention also provides the user(s) of the present various options on how (or which approach to use) to cleanse the data. That is, embodiments of the present invention provide the significant improvement to existing processes and methodologies to novelly improve data accuracy and/or the source of truth across the entirety an organization by allowing a user of the present invention to determine which data the user considers as the source of truth and, further, allowing the user to selectively update the various fields of data in the various tools of an organization. That is, in various embodiments, a user of the present invention is able to: 1) View the data—including consistencies and discrepancies; 2) Have a choice on which data to fix, and have a choice as to which data is the source of truth; 3) Create a Change Request; 4) Merge the data (and seek approvals, if needed); and 5) Complete and verify the operation. In various embodiments operations 1) through 5) above, are accomplished using, for example, one or more of GUI 1102 of FIG. 11, GUI 1202 of FIG. 12, GUI 1302 of FIG. 13, GUI 1402 of FIG. 14 and GUI 1502 of FIG. 15.

Also, because of the manual nature of conventional approaches, IT teams are often stuck in a “keep the lights on” (KTLO) mode. For example, users of conventional approaches are often left solely dealing with “solve this outage”, “figure out this thing”, and striving to get the inventory. Hence, users of conventional approaches are commonly spending up to 80 percent of their time on KTLO tasks.

Referring to another example, again assume that ROY and his architects, or other co-workers are senior employees of BigCo, assume that various network technicians, network engineers, network operators (and the like) are busily running around doing things at BigCo. In such a situation, embodiments of the present invention will uniquely create a curated list of prompt flows for ROY and his co-workers. Also, embodiments of the present invention enable ROY and his co-workers to specialize prompts. Moreover, various embodiments of the present invention uniquely allow ROY and his co-workers to create, capture, share, scale and modify institutional knowledge. Moreover, various embodiments of the present invention provide such significant improvements to an organization's operations in a manner that can be uniquely tailored or customized to meet the standard operating procedures, needs, requirements and/or preferences of the organization using, for example, GUIs 602, 702 and 802. Hence, ROY and his co-workers can troubleshoot issues without being burdened by totally random prompts or information. Additionally, in embodiments of the present invention, ROY and senior personnel in the architecture team are able to control the prompt flows before such prompt flows are provided to others within BigCo. That is, embodiments of the present invention dynamically and constantly upgrade prompt flows, thereby providing more improved prompt flows. For example, in embodiments of the present invention, if one approach to handling an incident is much better than another approach, the editable prompts of the present system and model are more accurate and more beneficial.

Also, embodiments of the present invention novelly and uniquely provide a system for an Enterprise to be able to create their own agents within their specific system or systems. In embodiments of the present invention, an agent (or “tech buddy”) herein referred to as NEO, is powered by an underlying AI-powered intelligence engine, and NEO is also an AI-engine. Thus, NEO is an AI-engine/companion that users of the present invention can actually manipulate and utilize for tasks as the user desires. Embodiments of the present invention have several different sources of knowledge for NEO, and embodiments of the present invention have different kinds of the knowledge that NEO provides. In embodiments of the present invention NEO can answer questions like, for example: “So, what needs to happen?”; “What is the information about this product?”; “What are the commands on this particular model of this product?”; “How do I troubleshoot this problem that I'm seeing here?”; and the like.

In various embodiments of the present invention NEO, is able to talk/communicate with another tech buddy. That is, in embodiments of the present invention provide the significant improvement to existing processes and methodologies to enable a first agent to talk/communicate with a second agent (or a plurality of other agents). Also, embodiments of the present invention provide the significant improvement to existing processes and methodologies in that various prompt flows will turn into word flows. For example, in embodiments of the present invention, assume that a provided agent is monitoring network traffic and also monitoring another agent. For example, one agent is checking network congestion or network usage, and another agent is monitoring hardware status. Embodiments of the present invention provide the significant improvement to existing processes and methodologies wherein when the agents are talking to each other, users can confidently assume that results from the present invention are accurate and fully data aware. That is, embodiments of the present invention provide the significant improvement to existing processes and methodologies wherein results are self-correcting due to appropriate training, tuning and pattern recognition. In embodiments of the present invention, all of the above is automated. As a result of the accuracy of the various embodiments of the present invention, users will immediately recognize the accuracy and benefits of the present invention, and users will trust the embodiments of the present invention for automation. Still another benefit of the embodiments of the present invention is that the source of truth for disparate systems within a company or organization, are developed and verified, for example, by the most relevant department and personnel of the company or organization. That is, in embodiments of the present invention the central source of truth system is owned by ownership of each particular domain within the company or organization. Also, unlike conventional approaches where each team communicates with other teams by, for example, picking up the phone and talking to another team, in embodiments of the present invention, disparate agents to talk to each other.

Also, various embodiments of the present invention include an orchestration agent (see e.g., FIG. 4). Embodiments of the present invention provide the significant improvement to existing processes and methodologies in that the orchestration agent is able to decide to which agent a particular task should be sent. Embodiments of the present invention further provide a significant improvement to existing processes and methodologies, in that the particular agent will obtain the appropriate data or information needed to handle the task and then return a result to the orchestration agent, and the present system and model will ultimately provide the solution to task to the user. Also, in embodiments of the present invention, prompt response is intentionally tied into the task. That is, embodiments of the present invention provide the significant improvement to existing processes and methodologies in that both the prompts and the results of the prompt are generated and/or provided in a user dependent and user specific UI (e.g., GUI 602 of FIG. 6, GUI 702 of FIG. 7 and/or GUI 802 of FIG. 8). Moreover, embodiments of the present invention are task specific as well, and contemplate contextual data. Also, embodiments of the present invention provide citations to the user. Hence, embodiments of the present invention provide the significant improvement to existing processes and methodologies by increasing trustworthiness.

Embodiments of the present invention gather such information, find conflicts in the information, and the embodiments of the present invention provide a valid and trustworthy source of truth to help users of the present invention confidently utilize the information. Additionally, embodiments of the present invention collect institutional knowledge which is, similarly, validated for source of truth. Further, in embodiments of the present invention, the AI-powered engine is queryable, from, for example, an IT team member. Also, embodiments of the present invention are self-training to improve results with continued use. Embodiments of the present invention improve the source of truth accuracy by running in these internal systems, by capturing institutional knowledge, and by further adjusting and verifying the source of truth as the present invention operates over time.

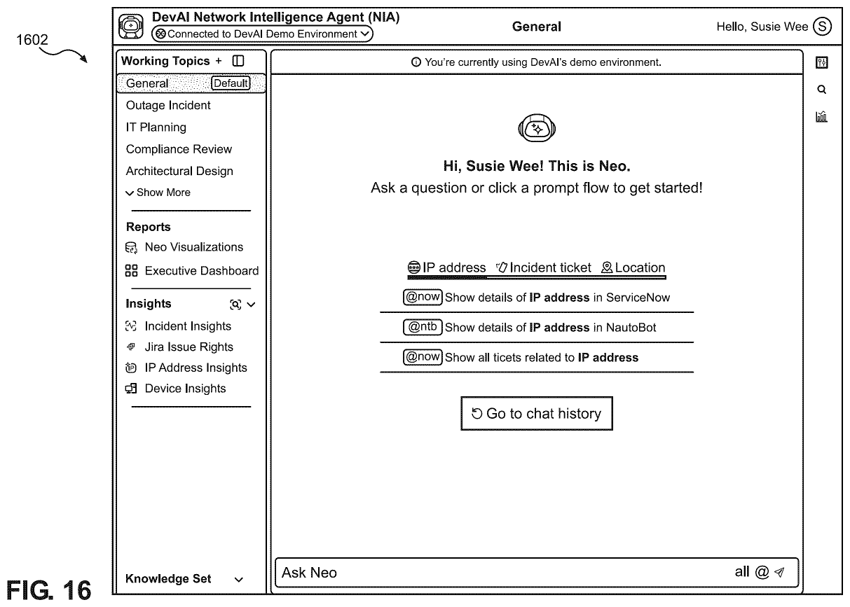

Embodiments of the present invention provide a productivity enhancement tool for various users. Conventionally, users had to run around between all these tools—while the same user may be getting bombarded with requests. And now, with embodiments of the present invention, a user can simply say “tech buddy show me the outage incidents that are going on and file the necessary tickets to get different parts of the work done”. Then the tech buddy of embodiments of the present invention runs through all of the relevant tools at the organization, the present invention gathers the data, and then the present invention delivers the answer to the user of the present invention. The tech buddy, for example, NEO, of embodiments of the present invention, will respond with “here is what I found after checking all the sources”. Additionally, in embodiments of the present invention, the user, who has to communicate the results to others, can simply say “NEO, write an incident report on this for me”. FIG. 16 is a GUI 1602 which can be used with in NEO, in various embodiments, for providing “Insights” and “Reports” functionality for a user of the present invention.

As an example of the benefits provided by embodiments of the present invention, consider IT tickets. With IT tickets, there may frequently be one or more users in the network operation center (NOC) having the skillset/ability to deal with the IT ticket. When such users come in in the morning, they look at all their dashboards and they see, oh, what went red. There's a couple of things like, oh, there's something going on in the UK and our London office. There's something going on there.

And then such personnel have to take each IT ticket, examine their available tools, find the error that resulted in the IT ticket, determine why the error is occurring, attempt to understand the issue(s) corresponding to the IT ticket, and then submit internal tickets describing the remediation work that needs to be done to solve the errors which caused the original IT ticket. The personnel dealing with the IT ticket may need to contact, for example, an internal (within the organization) service provider or an external (not within the organization) partner or service provider to, for example, provide better connectivity, provide more capacity, and the like. By utilizing various embodiments of the present invention, such personnel are saved considerable time per IT ticket. That is, conventionally, such personnel of an organization would need to perform the aforementioned steps and processes manually. Moreover, it is not unusual for such IT personnel to receive about tens of IT tickets each day. Thus, embodiments of the present invention easily provide numerous hours of savings per day for IT personnel handling IT tickets. Hence, embodiments of the present invention provide the significant improvement to existing processes and methodologies by freeing up the time of, for example, IT personnel and thereby providing an organization with additional IT personnel availability thereby adding capacity to the IT department. Thus, embodiments of the present invention provide the significant improvement to existing processes and methodologies by solving outages more quickly and significantly and favorably impacting an organization's ability to meet its business objectives.

Referring again to our tech buddy, NEO, in embodiments of the present invention users can ask NEO questions and other do various things with NEO. Consider ROY, or anyone whether you're an executive or not, you will typically have a number of projects that you're working on and always going back to. Let's consider an example where ROY's present project for a few weeks is handling the architectural design for ROY's next software-defined wide area network SD-Wan. ROY may be doing IT planning to look at budgeting for the next year while concurrently overseeing the outage incidents. Embodiments of the present invention make such multi-tasking practical for ROY. The graphic user interface of embodiments of the present invention (e.g., GUI 602 of FIG. 6, GUI 702 of FIG. 7 and/or GUI 802 of FIG. 8) enables a user, like ROY, to ask NEO a question or direct NEO to perform a needed task (or set of needed tasks) with confidence that NEO will return the correct and appropriate answer. Importantly, in embodiments of the present invention, NEO will also add context into the generated results. For example, when asking about industry information like IT planning, ROY might request, “list all the devices that we own that are marked end of life by the vendor”. In embodiments of the present invention, NEO might respond with, for example, “this set of devices”. Then, ROY might further request, “How many do we have that are manufactured by company A?” In embodiments of the present invention, NEO would respond with, for example, “54”. Thus, embodiments of the present invention NEO enables ROY to ask different kinds of personnel or “entity agents”, or even sub-agents, the questions that those agents or sub-agents are best equipped to answer.

Hence, embodiments of the present invention provide a significantly improved AI-powered engine that uniquely brings together industry domain knowledge, company institutional knowledge, and currently siloed Information Technology (IT) system data from, for example, CMDB tools, IPAM tools, observability tools, vendor tools, internal data, external data, employee notes, unstructured data, physio-network diagrams, whiteboards, electronic whiteboard documents, and the like. In so doing the present invention makes it possible for an organization to appropriately create, capture, share, scale and modify data and institutional knowledge.

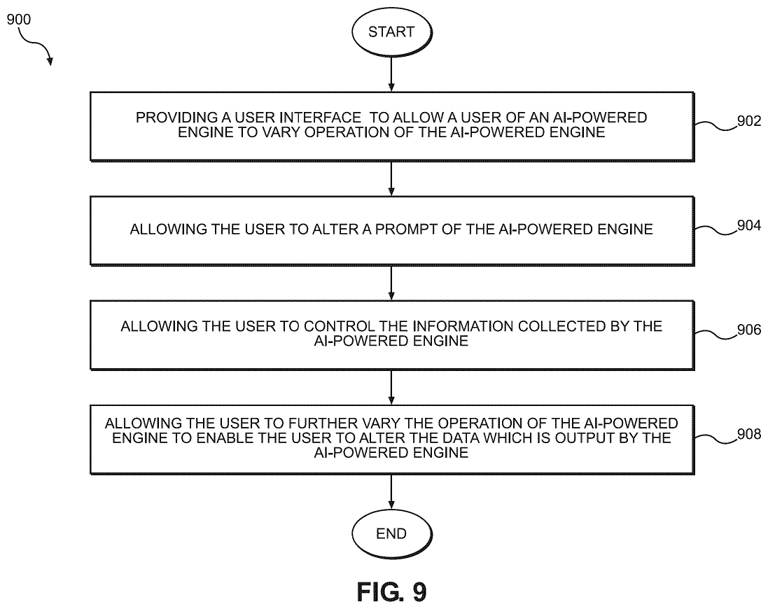

Referring now to FIG. 9, a flow chart 900 of steps performed by embodiments of the present invention is provided. At 902, embodiments of the present invention provide a user interface to allow a user of the AI-powered engine to vary operation of the AI-powered engine. At 904, embodiments of the present invention allow a user to alter a prompt of the AI-powered engine. At 906, embodiments of the present invention allow the user to control the information collected by the AI-powered engine. At 908, embodiments of the present invention allow the user to further vary the operation of the AI-powered engine to enable the user to alter the data which is output by the AI-powered engine.

### Example Computer System

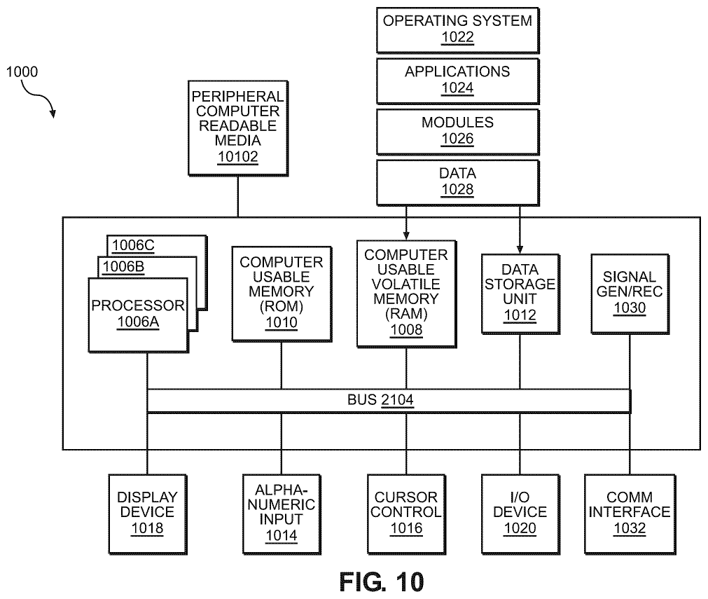

With reference now to FIG. 10, portions of the technology for providing a communication composed of computer-readable and computer-executable instructions that reside, for example, in non-transitory computer-readable medium (or storage media, etc.) of a computer system. FIG. 10 illustrates one example of a type of computer that can be used to implement embodiments of the present technology. FIG. 10 represents a system or components that may be used in conjunction with aspects of the present technology. In one embodiment, some or all of the components described herein may be combined with some or all of the components of FIG. 10 to practice the present technology.

FIG. 10 illustrates an example computer system 1000 used in accordance with embodiments of the present technology. It is appreciated that computer system 1000 of FIG. 10 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like with little modification. Moreover, it will be understood that computer system 1000 will often include, a computer processing unit(s) (CPU(s)) and/or a graphics processing unit(s) (GPU(s)). Furthermore, computer system 1000 may also include or operate in conjunction with on-premise, cloud, software as a system (SaaS), and hybrid cloud environments. As shown in FIG. 10, computer system 1000 of FIG. 10 is well adapted to having peripheral computer readable media 1002 such as, for example, a disk, a compact disc, a flash drive, and the like coupled thereto.

Computer system 1000 of FIG. 10 includes an address/data/control bus 1004 for communicating information, and a processor 1006A coupled to bus 1004 for processing information and instructions. As depicted in FIG. 10, computer system 1000 is also well suited to a multi-processor environment in which a plurality of processors 1006A, 1006B, and 1006C are present. Conversely, computer system 1000 is also well suited to having a single processor such as, for example, processor 1006A. Processors 1006A, 1006B, and 1006C may be any of various types of microprocessors. Computer system 1000 also includes data storage features such as a computer usable volatile memory 1008, e.g., random access memory (RAM), coupled to bus 1004 for storing information and instructions for processors 1006A, 1006B, and 1006C.

Computer system 1000 also includes computer usable non-volatile memory 1010, e.g., read only memory (ROM), coupled to bus 1004 for storing static information and instructions for processors 1006A, 1006B, and 1006C. Also present in computer system 1000 is a data storage unit 1012 (e.g., a magnetic disk drive, optical disk drive, solid state drive (SSD), and the like) coupled to bus 1004 for storing information and instructions. Computer system 1000 also can optionally include an alpha-numeric input device 1014 including alphanumeric and function keys coupled to bus 1004 for communicating information and command selections to processor 1006A or processors 1006A, 1006B, and 1006C. Computer system 1000 also can optionally include a cursor control device 1016 coupled to bus 1004 for communicating user input information and command selections to processor 1006A or processors 1006A, 1006B, and 1006C. Cursor control device may be a touch sensor, gesture recognition device, and the like. Computer system 1000 of the present embodiment can optionally include a display device 1018 coupled to bus 1004 for displaying information.

Referring still to FIG. 10, display device 1018 of FIG. 10 may be a liquid crystal device, cathode ray tube, OLED, plasma display device or other display device suitable for creating graphic images and alpha-numeric characters recognizable to a user. Cursor control device 1016 allows the computer user to dynamically signal the movement of a visible symbol (cursor) on a display screen of display device 1018. Many implementations of cursor control device 1016 are known in the art including a trackball, mouse, touch pad, joystick, non-contact input, gesture recognition, voice commands, bio recognition, and the like. In addition, special keys on alpha-numeric input device 1014 are capable of signaling movement of a given direction or manner of displacement. Alternatively, it will be appreciated that a cursor can be directed and/or activated via input from alpha-numeric input device 1014 using special keys and key sequence commands.

Computer system 1000 is also well suited to having a cursor directed by other means such as, for example, voice commands. Computer system 1000 also includes an I/O device 1020 for coupling computer system 1000 with external entities. For example, in one embodiment, I/O device 1020 is a modem for enabling wired or wireless communications between computer system 1000 and an external network such as, but not limited to, the Internet or intranet. A more detailed discussion of the present technology is found below.

Referring still to FIG. 10, various other components are depicted for computer system 1000. Specifically, when present, an operating system 1022, applications 1024, modules 1026, and data 1028 are shown as typically residing in one or some combination of computer usable volatile memory 1008, e.g. random-access memory (RAM), and data storage unit 1012. However, it is appreciated that in some embodiments, operating system 1022 may be stored in other locations such as on a network or on a flash drive; and that further, operating system 1022 may be accessed from a remote location via, for example, a coupling to the internet. In one embodiment, the present technology, for example, is stored as an application 1024 or module 1026 in memory locations within RAM 1008 and memory areas within data storage unit 1012. The present technology may be applied to one or more elements of described computer system 1000.

Computer system 1000 also includes one or more signal generating and receiving device(s) 1030 coupled with bus 1004 for enabling computer system 1000 to interface with other electronic devices and computer systems. Signal generating and receiving device(s) 1030 of the present embodiment may include wired serial adaptors, modems, and network adaptors, wireless modems, and wireless network adaptors, and other such communication technology. The signal generating and receiving device(s) 1030 may work in conjunction with one (or more) communication interface 1032 for coupling information to and/or from computer system 1000. Communication interface 1032 may include a serial port, parallel port, Universal Serial Bus (USB), Ethernet port, Bluetooth, thunderbolt, near field communications port, Wi-Fi, Cellular modem, or other input/output interface. Communication interface 1032 may physically, electrically, optically, or wirelessly (e.g., via radio frequency) couple computer system 1000 with another device, such as a mobile phone, radio, or computer system.

Computer system 1000 is only one example of a suitable computing environment and is not intended to suggest any limitation as to the scope of use or functionality of the present technology. Neither should the computing environment be interpreted as having any dependency or requirement relating to any one component, or a combination of components, illustrated in the example computer system 1000.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. An artificial intelligence (AI)-powered engine method for collecting information and outputting data; said method comprising:
providing a user interface to allow a user of said AI-powered engine to vary operation of said AI-powered engine;
allowing said user to alter a prompt of said AI-powered engine;
allowing said user to control said information collected by said AI-powered engine; and
allowing said user to further vary said operation of said AI-powered engine to enable said user to alter said data which is output by said AI-powered engine.
